(19) United States
(12) Patent Application Publication
(10) Pub. No.: US 2008/0271237 A1
(43) Pub. Date: Nov. 6, 2008

(54) Hydro-massage device for bathtub

(76) Inventor: Chin-Lun Chang, Changhua Hsien (TW)

Correspondence Address: Brinks Hofer Gilson & Lione/Ann Arbor, 524 South Main Street, Suite 200, Ann Arbor, MI, 48104, US

(21) Appl. No.: 11/799,493

(22) Filed: May 1, 2007

(51) Int. Cl. A61H 9/00

(52) U.S. Cl. 4/541.3

(57) ABSTRACT

A hydro-massage device for a bathtub includes a first water conduit unit in fluid communication with an inlet unit of a main pump and having a water inlet unit adapted to be disposed in the bathtub and adapted to be in fluid communication with a water source such that the main pump is filled with water from the water source when the water is supplied to the first water conduit unit via the water inlet unit, and a second water conduit unit in fluid communication with an outlet unit of the main pump and having a nozzle end that is adapted to be disposed in the bathtub. Water spouts are formed at the nozzle end when the main pump is activated. A control unit is operable so as to drain water from the main pump via one of the inlet and outlet units after deactivation of the main pump.

### BACKGROUND OF THE INVENTION

1. Field of the Invention

The invention relates to a massage device, more particularly to a hydro-massage device for a bathtub.

2. Description of the Related Art

FIG. 1 illustrates a conventional hydro-massage device for a bathtub 100 that includes a pump 1, a mounting seat 2 mounted in the bathtub 100, a first water conduit 101 in fluid communication with the pump 1 and having an inlet end 1011 that is disposed in the bathtub 100, and a second water conduit 102 in fluid communication with the pump 1 and having a nozzle end 1021 mounted pivotally to the mounting seat 2. During use, water in the bathtub 100 is supplied to the first water conduit 101 via the inlet end 1011, and is pumped by the pump 1 to the second water conduit 102, thereby generating a plurality of water spouts at the nozzle end 1021 of the second water conduit 102 for hydro-massage purposes.

In such a configuration, it is noted that water in the pump 1 cannot be drained after use, thereby resulting in stink and germs generated in the pump 1.

### SUMMARY OF THE INVENTION

Therefore, the object of the present invention is to provide a hydro-massage device that can overcome the aforesaid drawback of the prior art.

According to the present invention, there is provided a hydro-massage device adapted for use with a bathtub. The hydro-massage device comprises:

a main pump having an inlet unit and an outlet unit;

a first water conduit unit in fluid communication with the inlet unit of the main pump and having a water inlet unit adapted to be disposed in the bathtub and adapted to be in fluid communication with a water source such that the main pump is filled with water from the water source when the water is supplied to the first water conduit unit via the water inlet unit;

a second water conduit unit in fluid communication with the outlet unit of the main pump and having a nozzle end that is adapted to be disposed in the bathtub, water spouts being formed at the nozzle end when the main pump is activated; and

a control unit operable so as to drain water from the main pump via one of the inlet and outlet units after deactivation of the main pump.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional hydro-massage device;

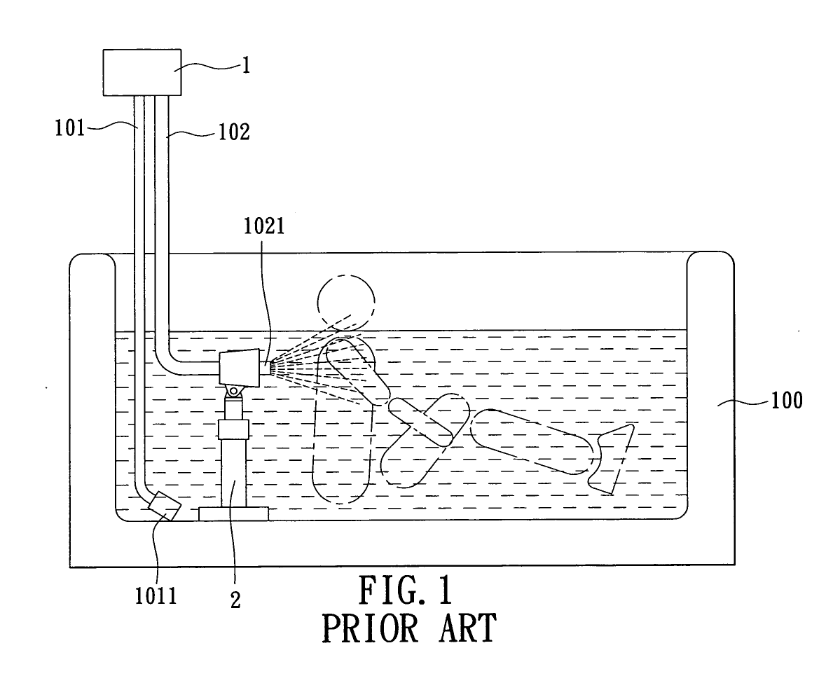

FIG. 2 is a schematic view showing the first preferred embodiment of a hydro-massage device according to the present invention;

FIG. 3 is a schematic view showing the second preferred embodiment of a hydro-massage device according to the present invention;

FIG. 4 is a schematic view showing the third preferred embodiment of a hydro-massage device according to the present invention;

FIG. 5 is a schematic view showing the fourth preferred embodiment of a hydro-massage device according to the present invention, wherein a four-way three-position valve of the fourth preferred embodiment is disposed in a normal position;

FIG. 5a is a schematic circuit block diagram illustrating the fourth preferred embodiment;

FIG. 6 is a schematic view showing the fourth preferred embodiment when the four-way three-position valve is disposed in a water-supplying position; and

FIG. 7 is a schematic view showing the fourth preferred embodiment when the four-way three-position valve is disposed in a water-draining position.

### DETAILED DESCRIPTION OF THE PREFERRED EMBODIMENTS

Before the present invention is described in greater detail, it should be noted that like elements are denoted by the same reference numerals throughout the disclosure.

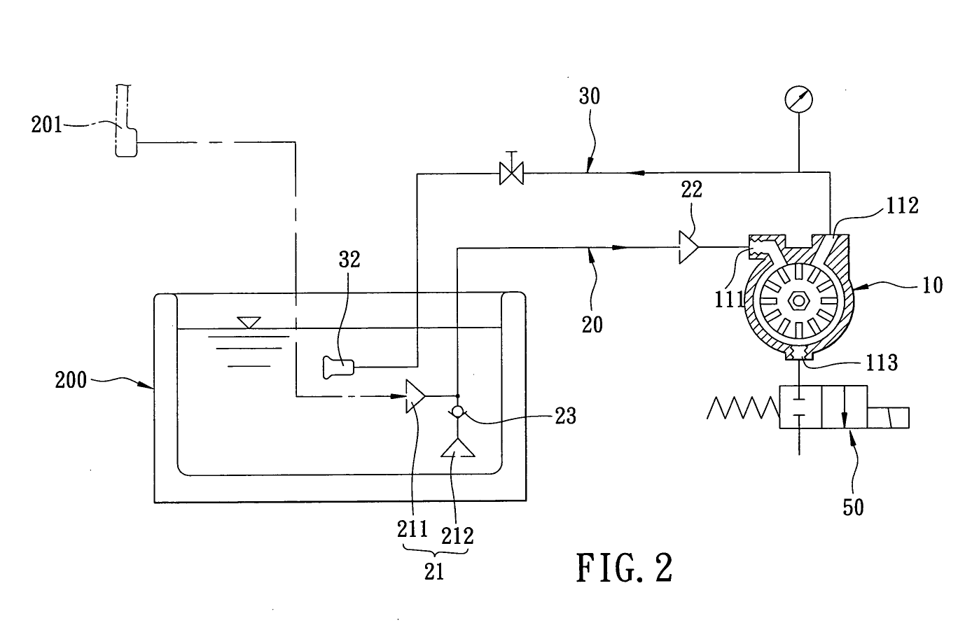

Referring to FIG. 2, the first preferred embodiment of a hydro-massage device according to the present invention is shown to be adapted for use with a bathtub 200 and includes a main pump 10, a first water conduit unit 20, a second water conduit unit 30, and a control unit.

The main pump 10 is a high-voltage pump having about 1 horsepower, and has an inlet unit and an outlet unit. In this embodiment, the inlet unit includes an inlet 111, and the outlet unit includes a first outlet 112, and a second outlet 113 disposed at a bottom of the main pump 10.

The first water conduit unit 20 is in fluid communication with the first inlet 111 of the inlet unit of the main pump 10, and has a water inlet unit 21 adapted to be disposed in the bathtub 200 and adapted to be in fluid communication with a water source such that the main pump 10 is filled with water from the water source when the water is supplied to the first water conduit unit 20 via the water inlet unit 21. The water source is water in the bathtub 200. The water inlet unit 21 of the first water conduit unit 20 includes first and second water inlets 211, 212. The water from the water source is supplied to the first water conduit unit 20 via the first water inlet 211 prior to activation of the main pump 10, and via the second water inlet 212 when the main pump 10 is activated. In this embodiment, prior to activation of the main pump 10, the water source is preferably a home water source such that the water from the home water source can be supplied to the first water conduit unit 20 via the first water inlet 211 using a shower nozzle 201. The first water conduit unit 20 is provided with a filter 22 disposed adjacent to the inlet 111 of the main pump 10, and a one-way valve 23 disposed adjacent to the second water inlet 212 of the water inlet unit 21 for preventing flowing of water out of the first water conduit unit 20 via the second water inlet 212 of the water inlet unit 21.

In this embodiment, the second water conduit unit 30 is in fluid communication with the first outlet 112 of the outlet unit of the main pump 10, and has a nozzle end 32 that is adapted to be disposed in the bathtub 200. Water spouts are formed at the nozzle end 32 when the main pump 10 is activated.

In this embodiment, the control unit includes a control valve 50, such as an electromagnetic valve, that is mounted on the bottom of the main pump 10. The control valve 50 is operable so as to drain water from the main pump 10 via the second outlet 113 of the outlet unit of the main pump 10 after deactivation of the main pump 10.

In use, the bathtub 200 must be filled with a sufficient amount of water for use as the water source when the main pump 10 is activated. Prior to activation of the main pump 10, water is supplied from the water source, i.e., the home water source, to the first water conduit unit 20 via the first water inlet 211 of the water inlet unit 21 using the shower nozzle 201 and then into the main pump 10 until the main pump 10 is fully filled with the water from the water source. Subsequently, the main pump 10 is activated so as to draw water from the bathtub 200 into the first water conduit unit 20 via the second water inlet 212 of the water inlet unit 21. Hence, the water spouts are continuously formed at the nozzle end 32 of the second water conduit unit 30, thereby attaining hydro-massage purpose. After deactivation of the main pump 10, the control valve 50 is operated so as to drain water from the main pump 10 via the second outlet 113 of the outlet unit of the main pump 10.

In such a configuration, the hydro-massage device of the present invention can be easily installed and has a relatively simple configuration as compared to the aforesaid conventional hydro-massage device. Furthermore, since the water can be drained from the main pump 10 after deactivation of the main pump 10, generation of stink and germs in the main pump 10 can be minimized.

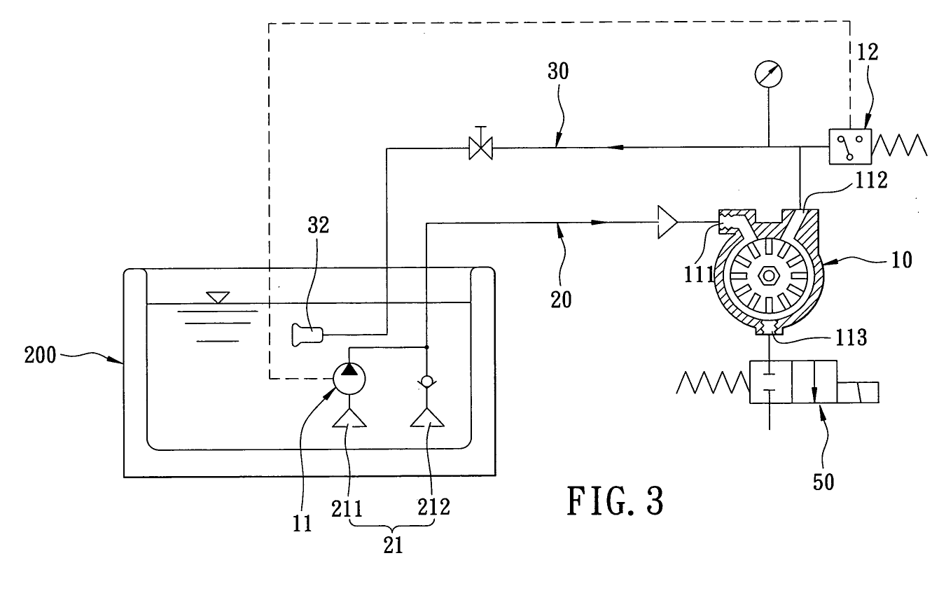

FIG. 3 illustrates the second preferred embodiment of a hydro-massage device according to this invention, which is a modification of the first preferred embodiment. In this embodiment, the hydro-massage device further includes an auxiliary pump 11 and a control switch 12.

The auxiliary pump 11 is a waterproof low-voltage pump having about 1/30 horsepower, is in fluid communication with the first water conduit unit 20, and is disposed adjacent to the first water inlet 211 of the water inlet unit 21 of the first water conduit unit 20 for pressurizing the water source, i.e., the water in the bathtub 200, prior to activation of the main pump 10 such that the water is pumped from the water source into the first water conduit unit 20 via the first water inlet 211 of the water inlet unit 21.

The control switch 12 is connected electrically to the auxiliary pump 11 and is operable so as to deactivate the auxiliary pump 11 upon detecting that the main pump 10 is fully filled with the water from the water source via the first water inlet 211 of the water inlet unit 21 of the first water conduit unit 20 prior to activation of the main pump 10. In this embodiment, the control valve 12 is mounted at the first outlet 112 of the outlet unit of the main pump 10, and is activated in response to a water pressure condition in the main pump 10, where the main pump 10 is fully filled with the water from the water source via the first water inlet 211 of the water inlet unit 21 of the first water conduit unit 20, so as to deactivate the auxiliary pump 11 prior to activation of the main pump 10.

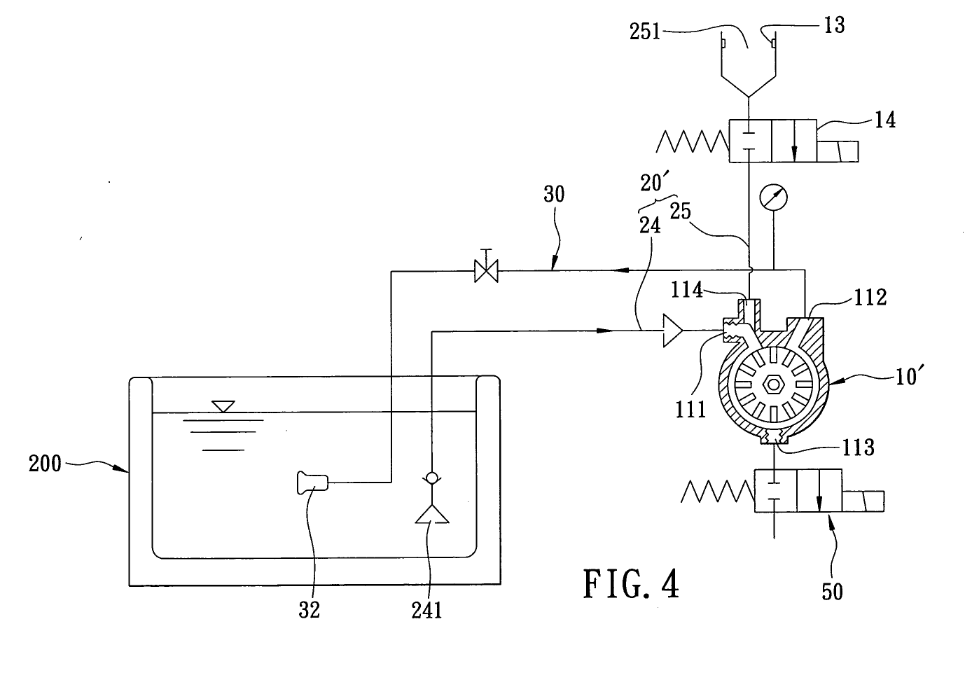

FIG. 4 illustrates the third preferred embodiment of a hydro-massage device according to this invention, which is a modification of the first preferred embodiment. Unlike the first preferred embodiment, the inlet unit of the main pump 10′ includes a first inlet 111, and a second inlet 114 disposed at a top of the main pump 10′. The first water conduit unit 20′ includes a main water conduit 24 in fluid communication with the first inlet 111 of the inlet unit of the main pump 10′ and having a main water inlet 241, and an auxiliary water conduit 25 in fluid communication with the second inlet 114 of the inlet unit of the main pump 10′ and having an auxiliary water inlet 251 that is disposed above the second inlet 114 of the inlet unit of the main pump 10′. The main water inlet 241 of the main water conduit 24 and the auxiliary water inlet 251 of the auxiliary water conduit 25 constitute the water inlet unit of the first water conduit unit 20′. Water is supplied from the home water source, which serves as the water source, into the auxiliary water conduit 25 of the first water conduit unit 20′ via the auxiliary water inlet 251 prior to activation of the main pump 10′. On the other hand, when the main pump 10′ is activated, the water in the bathtub 200 is drawn into the main water conduit 24 of the first water conduit unit 20′ via the main water inlet 241.

In this embodiment, the hydro-massage device further includes a sensor 13 and an electromagnetic valve 14. The sensor 13 is disposed at the auxiliary water inlet 251 of the auxiliary water conduit 25 of the first water conduit unit 20′. The electromagnetic valve 14 is disposed adjacent to the auxiliary water inlet 251 of the auxiliary water conduit 25 of the first water conduit unit 20′, and is operable so as to terminate supply of the water from the water source via the auxiliary water inlet 251 upon detection by the sensor 13 that the main pump 10′ is fully filled with the water from the water source via the auxiliary water inlet 251 of the auxiliary water conduit 25 prior to activation of the main pump 10′.

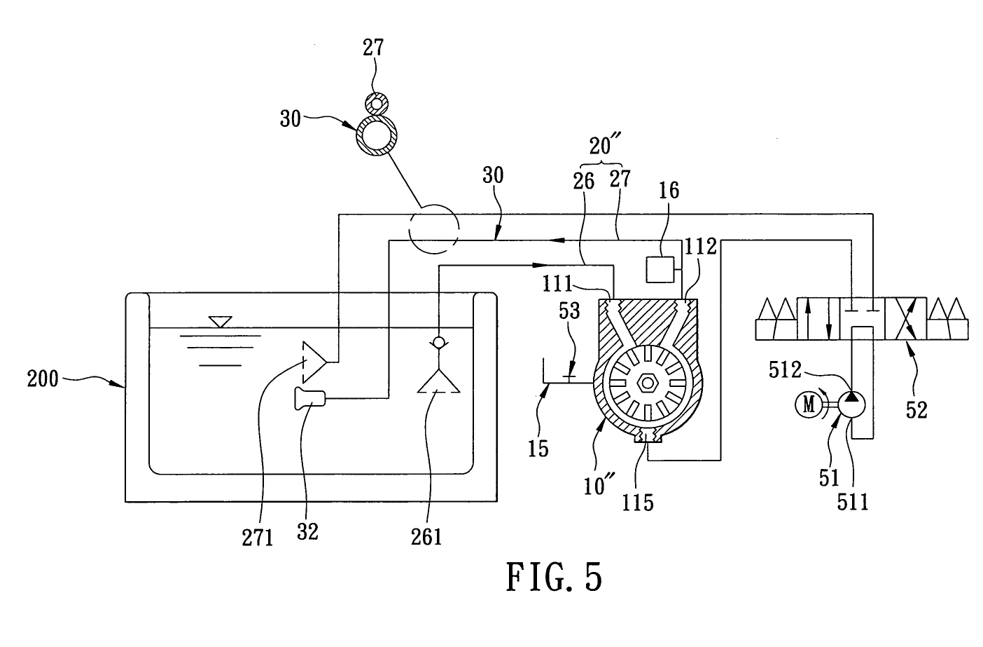

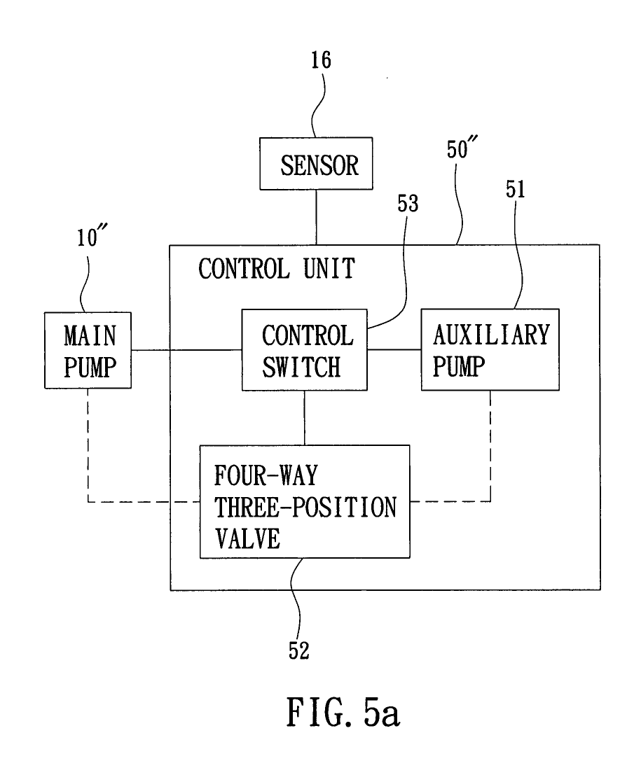

FIGS. 5 to 7 illustrate the fourth preferred embodiment of a hydro-massage device according to this invention, which is a modification of the first preferred embodiment. Unlike the first preferred embodiment, the inlet unit of the main pump 10″ includes a first inlet 111, and a second inlet 115 disposed at a bottom of the main pump 10″.

The first water conduit unit 20″ includes a main water conduit 26 in fluid communication with the first inlet 111 of the inlet unit of the main pump 10″ and having a main water inlet 261, and an auxiliary water conduit 27 having an auxiliary water inlet 271 adapted to be disposed in the bathtub 200. The main water inlet 261 of the main water conduit 26 and the auxiliary water inlet 271 of the auxiliary water conduit 27 constitute the water inlet unit of the first water conduit unit 20″. In this embodiment, the auxiliary water conduit 27 of the first water conduit unit 20″ has an inner diameter of 3 mm, whereas the second water conduit unit 30 includes a water conduit having an inner diameter of 17 mm.

In this embodiment, referring further to FIG. 5a, the control unit 50″ includes an auxiliary pump 51, a four-way three-position valve 52, and a control switch 53.

The auxiliary pump 51 has an inlet 511 and an outlet 512.

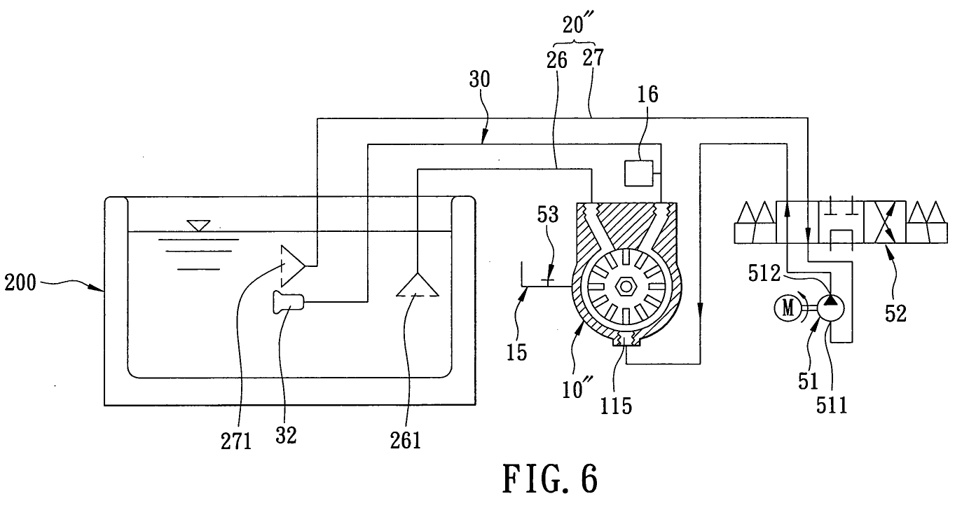

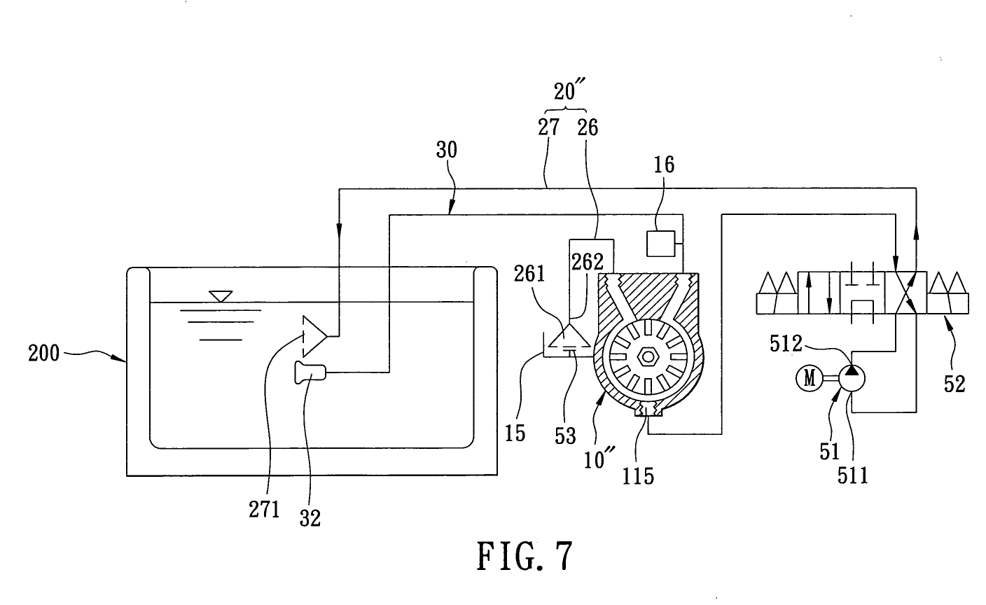

The four-way three-position valve 52 is disposed among the second inlet 115 of the inlet unit of the main pump 10″, the auxiliary water conduit 27 of the first water conduit unit 20″ and the auxiliary pump 51. The four-way three-position valve 52 is operable so as to switch among a normal position shown in FIG. 5, where the auxiliary water conduit 27 of the first water conduit unit 20″ and the second inlet 115 of the inlet unit of the main pump 10″ are closed and where the inlet 511 and the outlet 512 of the auxiliary pump 51 are in fluid communication with each other, a water-supplying position shown in FIG. 6, where the inlet 511 is in fluid communication with the auxiliary water conduit 27 of the first water conduit unit 20″ and where the outlet 512 of the auxiliary pump 51 is in fluid communication with the second inlet 115 of the inlet unit of the main pump 10″, and a water-draining position shown in FIG. 7, where the inlet 511 of the auxiliary pump 51 is in fluid communication with the second inlet 115 of the inlet unit of the main pump 10″ and where the outlet 512 of the auxiliary pump 51 is in fluid communication with the auxiliary water conduit 27 of the first water conduit unit 20″.

The control switch 53 is connected electrically to the main pump 10″, the four-way three-position valve 52 and the auxiliary pump 51. The control switch 53 is operable so as to control the hydro-massage device to be operated in an initial state, at the time of actuation of the hydro-massage device, where the auxiliary pump 51 is activated and the main pump 10″ is deactivated, and where the four-way three-position valve 52 is disposed in the water-supplying position such that water is supplied from the water source (i.e., water in the bathtub 200) into the auxiliary water conduit 27 of the first water conduit unit 20″ via the auxiliary water inlet 271, and is pumped by the auxiliary pump 51 into the main pump 10″ via the second inlet 115 of the inlet unit of the main pump 10″, as shown in FIG. 6, a use state, upon detection by a sensor 16 that the main pump 10″ is fully filled with the water from the water source, where the main pump 10″ is activated and the auxiliary pump 51 is deactivated, and where the four-way three-position valve 52 is disposed in the normal position such that water is drawn from the water source into the main water conduit 26 of the first water conduit unit 20″ via the main water inlet 261, and is pumped by the main pump 10″ into the second first water conduit unit 30, thereby generating the water spouts at the nozzle end 32 of the second water conduit unit 30, as shown in FIG. 5, and an ending state, where the main pump 10″ is deactivated and the auxiliary pump 51 is activated, and where the four-way three-position valve 52 is disposed in the water-draining position such that water is pumped by the auxiliary pump 51 out of the main pump 10″ via the second inlet 115 of the inlet unit of the main pump 115 and the auxiliary water conduit 27 of the first water conduit unit 20″, as shown in FIG. 7.

In this embodiment, the control switch 53 is mounted in an inserting seat 15, which is disposed adjacent to the main pump 10″. The control switch 53 is operated by, for example, inserting an end 262 of the main water conduit 26 having the main water inlet 261 into the inserting seat 15 (see FIG. 7) so as to control the hydro-massage device to switch from the use state to the ending state. Subsequently, the four-way three-position valve 52 can also be controlled by the same operation of the control switch 53 to switch from the water-draining position to the normal position when the hydro-massage device is deactivated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A hydro-massage device adapted for use with a bathtub, comprising:
a main pump having an inlet unit and an outlet unit;
a first water conduit unit in fluid communication with said inlet unit of said main pump and having a water inlet unit adapted to be disposed in the bathtub and adapted to be in fluid communication with a water source such that said main pump is filled with water from the water source when the water is supplied to said first water conduit unit via said water inlet unit;
a second water conduit unit in fluid communication with said outlet unit of said main pump and having a nozzle end that is adapted to be disposed in the bathtub, water spouts being formed at said nozzle end when said main pump is activated; and
a control unit operable so as to drain water from said main pump via one of said inlet and outlet units after deactivation of said main pump.

2. The hydro-massage device as claimed in claim 1, wherein:
said control unit includes a control valve; and
said outlet unit of said main pump has a first outlet in fluid communication with said second water conduit unit, and a second outlet disposed at a bottom of said main pump and connected to said control valve such that the water is drained from said main pump via said second outlet after deactivation of said main pump and when said control valve is operated.

3. The hydro-massage device as claimed in claim 2, wherein said water inlet unit of said first water conduit unit includes first and second water inlets, the water from the water source being supplied to said first water conduit unit via said first water inlet prior to activation of said main pump, and via said second water inlet when said main pump is activated.

4. The hydro-massage device as claimed in claim 3, further comprising an auxiliary pump for pressurizing the water source prior to activation of said main pump such that the water from the water source is injected into said first water conduit unit via said first water inlet of said water inlet unit of said first water conduit unit.

5. The hydro-massage device as claimed in claim 4, further comprising a control switch connected electrically to said auxiliary pump and operable so as to deactivate said auxiliary pump upon detecting that said main pump is fully filled with the water from the water source via said first water inlet of said water inlet unit of said first water conduit unit prior to activation of said main pump.

6. The hydro-massage device as claimed in claim 5, wherein said control switch is mounted at said first outlet of said outlet unit of said main pump, and is activated in response to a water pressure condition in said main pump, where said main pump is fully filled with the water from the water source via said first water inlet of said water inlet unit of said first water conduit unit, so as to deactivate said auxiliary pump prior to activation of said main pump.

7. The hydro-massage device as claimed in claim 2, wherein:
said inlet unit of said main pump includes a first inlet, and a second inlet disposed at a top of said main pump; and
said first water conduit unit includes a main water conduit in fluid communication with said first inlet of said inlet unit of said main pump and having a main water inlet, and an auxiliary water conduit in fluid communication with said second inlet of said inlet unit of said main pump and having an auxiliary water inlet, said main water inlet of said main water conduit and said auxiliary water inlet of said auxiliary water conduit constituting said water inlet unit of said first water conduit unit, the water from the water source being supplied to said auxiliary water conduit of said first water conduit unit via said auxiliary water inlet prior to activation of said main pump, and to said main water conduit of said first water conduit unit via said main water inlet when said main pump is activated;
said hydro-massage device further comprising:
a sensor disposed at said auxiliary water inlet of said auxiliary water conduit of said first water conduit unit; and
an electromagnetic valve in fluid communication with said auxiliary water inlet of said auxiliary water conduit of said first water conduit unit and operable so as to terminate supply of the water from the water source via said auxiliary water inlet upon detection by said sensor that said main pump is fully filled with the water from the water source via said auxiliary water inlet of said auxiliary water conduit prior to activation of said main pump.

8. The hydro-massage device as claimed in claim 1, wherein:
said inlet unit of said main pump includes a first inlet and a second inlet;
said first water conduit unit includes a main water conduit in fluid communication with said first inlet of said inlet unit of said main pump and having a main water inlet, and an auxiliary water conduit having an auxiliary water inlet, said main water inlet and said auxiliary water inlet constituting said water inlet unit; and
said control unit includes
an auxiliary pump having an inlet and an outlet,
a four-way three-position valve disposed among said second inlet of said inlet unit of said main pump, said auxiliary water conduit of said first water conduit unit and said auxiliary pump, and operable so as to switch among a normal position, where said auxiliary water conduit of said first water conduit unit and said second inlet of said inlet unit of said main pump are closed and where said inlet and said outlet of said auxiliary pump are in fluid communication with each other, a water-supplying position, where said inlet of said auxiliary pump is in fluid communication with said auxiliary water conduit of said first water conduit unit and where said outlet of said auxiliary pump is in fluid communication with said second inlet of said inlet unit of said main pump, and a water-draining position, where said inlet of said auxiliary pump is in fluid communication with said second inlet of said inlet unit of said main pump and where said outlet of said auxiliary pump is in fluid communication with said auxiliary water conduit of said first water conduit unit, and
a control switch connected electrically to said main pump, said four-way three-position valve and said auxiliary pump, said control switch being operable so as to control said hydro-massage device to be operated in an initial state, at the time of actuation of said hydro-massage device, where said auxiliary pump is activated and said main pump is deactivated, and where said four-way three-position valve is disposed in the water-supplying position such that the water from the water source is supplied to said auxiliary water conduit of said first water conduit unit via said auxiliary water inlet, and is pumped by said auxiliary pump into said main pump via said second inlet of said inlet unit of said main pump, a use state, upon detecting that said main pump is fully filled with the water from the water source, where said main pump is activated and said auxiliary pump is deactivated, and where said four-way three-position valve is disposed in the normal position such that the water from the water source is supplied to said main water conduit of said first water conduit unit via said main water inlet, and is pumped by said main pump to said second water conduit unit, thereby generating said water spouts at said nozzle end of said second water conduit unit, and an ending state, where said main pump is deactivated and said auxiliary pump is activated, and where said four-way three-position valve is disposed in the water-draining position such that water is pumped by said auxiliary pump out of said main pump via said second inlet of said inlet unit of said main pump and said auxiliary water conduit of said first water conduit unit.

9. The hydro-massage device as claimed in claim 8, further comprising an inserting seat disposed adjacent to said main pump, said control switch being disposed in said inserting seat and being operable so as to control said four-way three-position valve to switch to the normal position.
